(19) United States
(12) Patent Application Publication
(10) Pub. No.: US 2008/0068697 A1
(43) Pub. Date: Mar. 20, 2008

(54) Micro-Displays and Their Manufacture

(76) Inventors: Charles C. Haluzak, Corvallis, OR (US); Kenneth Faase, Corvallis, OR (US); John R. Sterner, Albany, OR (US); Chien-Hua Chen, Corvallis, OR (US); Kirby Sand, Corvallis, OR (US); Bao-Sung Bruce Yeh, Corvallis, OR (US); Michael J. Regan, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/933,930

(22) Filed: Nov. 1, 2007

Related U.S. Application Data
(62) Division of application No. 10/977,278, filed on Oct. 29, 2004, now Pat. No. 7,320,899.

(51) Int. Cl. G02B 26/08; B05D 5/06; G02B 1/10

(52) U.S. Cl. 359/224; 359/839; 427/162

(57) ABSTRACT

A method of forming a micro-display includes forming a device that includes forming a partially reflecting layer on a first substrate and forming a plate overlying the partially reflecting layer, and adhering the device to a second substrate.

### CLAIM OF PRIORITY

This application claims the benefit of U.S. Provisional Application No. __/___,___, filed on Oct. 21, 2004, entitled MICRO-DISPLAYS AND THEIR MANUFACTURE, and having express mail label number EL871865948 US (Attorney Docket Number 200402524-1).

### BACKGROUND

Digital projectors often include micro-displays that include arrays of pixels (e.g., 1028×1024, etc.) Each pixel usually includes a micro-electromechanical system (MEMS) device, such as a micro-mirror, liquid crystal on silicon (LcoS) device, interference-based modulator, etc. A micro-display is used with a light source and projection lens of the digital projector. The micro-display receives light from the light source. When the pixels of the micro-display are ON, the pixels direct the light to the projection lens. When the pixels are OFF, they direct the light from the light source away from the projection lens. The projection lens images and magnifies the micro-display.

Micro-displays are usually formed using semiconductor-processing methods that include forming electronic driver circuits on a semiconductor substrate for driving the MEMS devices of the pixels. The electronic driver circuits are often Complementary Metal Oxide Semiconductor (CMOS) devices. After forming the electronic driver circuits, the MEMS devices are formed overlying the electronic driver circuits and a transparent, e.g., glass, cover is formed overlying the MEMS devices for packaging, e.g., sealing and/or protecting, the MEMS devices and the electronic driver circuits.

### DESCRIPTION OF THE DRAWINGS

FIG. 1 is a schematic of an embodiment of a micro-display, according to an embodiment of the disclosure.

FIGS. 2A-2L are cross-sections of a portion of an embodiment of a micro display at various stages of fabrication, according to another embodiment of the disclosure.

### DETAILED DESCRIPTION

In the following detailed description of the present embodiments, reference is made to the accompanying drawings that form a part hereof, and in which is shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

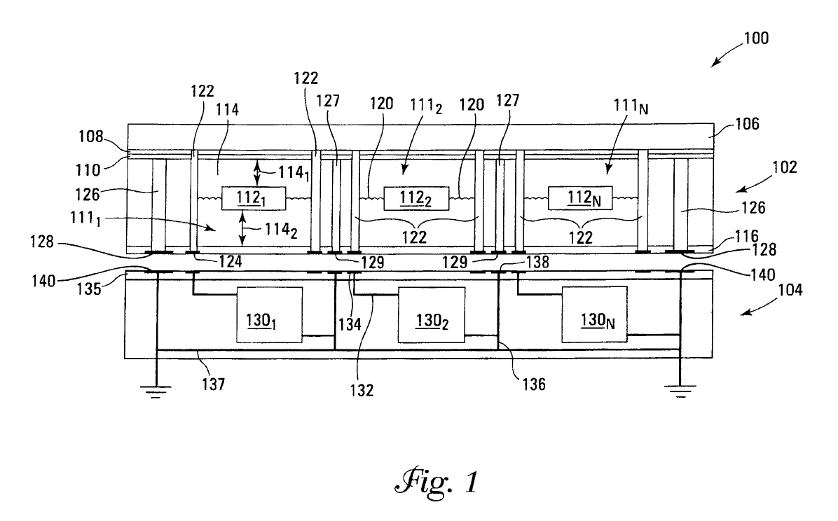

FIG. 1 is a schematic of a micro-display 100, e.g., as a portion of a digital projector, according to an embodiment. For one embodiment, micro-display 100 functions as a light modulator of the digital projector. For another embodiment, micro-display 100 includes a device 102 and a driver 104. For some embodiments, device 102 includes one or more micro-electromechanical system (MEMS) devices 111, such as micro-mirrors, liquid crystal on silicon (LcoS) devices, interference-based modulators, etc. For other embodiments, device 102 and driver 104 are formed separately and are subsequently bonded together.

For one embodiment, device 102 includes a substrate 106, such as a transparent cover, e.g., of glass. For another embodiment, a transparent layer 108, e.g., of TEOS (tetraethylorthosilicate) oxide, silicon oxide, etc., is formed on substrate 106. A partially reflecting layer 110, e.g., a tantalum-aluminum (TaAl) layer, is formed on transparent layer 108. For other embodiments, partially reflecting layer 110 may be formed directly on substrate 106. For other embodiments, partially reflecting layer 110 forms a first capacitor plate of device 102.

Device 102 also includes pixel plates 112, e.g., as a portion of the MEMS devices 111, that are suspended by flexures 120 within a gap 114 located between partially reflecting layer 110 and a protective layer 116, e.g., of TEOS (tetraethylorthosilicate) oxide, silicon oxide, etc. Specifically, a first gap portion 114₁ of gap 114 separates a pixel plate 112 from partially reflecting layer 110, and a second gap portion 114₂ of gap 114 separates a pixel plate 112 from protective layer 116. For one embodiment, pixel plates 112 form second capacitor plates of device 102.

Flexures 120 electrically connect their respective pixel plates to one or more signal posts 122 that terminate at signal contacts 124 formed on protective layer 116. For one embodiment, pixel plates 112 are of a aluminum-copper (AlCu) alloy that acts like a mirror. For another embodiment, pixel plates 112 include a layer of TaAl formed on a layer of AlCu, where the AlCu layer faces partially reflecting layer 110.

For one embodiment, a bond ring 126 is electrically connected to partially reflecting layer 110 and terminates at ground contacts 128 formed on protective layer 116. For some embodiments, bond ring 126 also provides support between substrate 106 and protective layer 116. For another embodiment, ground posts 127 are also electrically connected to partially reflecting layer 110 and terminate at ground contacts 129 formed on protective layer 116. Ground posts 127 may also provide support between substrate 106 and protective layer 116, for some embodiments.

For one embodiment, driver 104 is Complementary Metal Oxide Semiconductor (CMOS) substrate. Driver 104 can be formed using semiconductor-processing methods known to those skilled in the art. Driver 104 includes driver circuits 130 adapted to respectively control the positions of pixel plates 112 and thus the corresponding gaps 114. Each of driver circuits 130 is connected between a signal supply line 132 and a ground line 136. Signal supply line 132 terminates at a signal contact 134 formed in a protective layer 135, e.g., of TEOS (tetraethylorthosilicate) oxide, silicon oxide, etc. Ground line 136 is connected between a main ground line 137 and a ground contact 138 formed in protective layer 135.

Driver 104 is electrically connected to device 102, for one embodiment, by bonding ground contacts 129 to ground contacts 138 to connect ground posts 127, and thus partially reflecting layer 110, to ground, and by bonding signal contacts 124 to signal contacts 134 to connect driver circuits 130 to signal posts 122 and thus to pixel plates 112. For another embodiment, main ground line 137 may also be separately connected to ground contacts 128 by bonding ground contacts 128 to ground contacts 140 formed in protective layer 135 and connected to main ground line 137. This connects seal ring 126, and thus further connects partially reflecting layer 110, to ground. For another embodiment, the contacts may be soldered together. For other embodiments, protective layers 116 and 135 are bonded together using plasma-enhanced bonding so that the contacts abut each other.

For another embodiment, ground posts 127 and/or bond ring 126, signal posts 122, pixel plates 112, and flexures 120 are formed as a part of driver 104 using semiconductor-processing methods. For this embodiment, partially reflecting layer 110 is formed on substrate 106, e.g., by chemical vapor deposition. Partially reflecting layer 110 is then bonded, e.g., by gluing, plasma-enhanced bonding, or the like, to ground posts 127 and/or bond ring 126. This acts to reduce the number of processing steps compared to where transparent layer 108 is disposed on the substrate 106 prior to partially reflecting layer 110, as discussed above and shown in FIG. 1.

In operation, driver circuits 130 respectively send signals via signal lines 132, signal posts 122, and flexures 120 to pixel plates 112. This creates potentials between partially reflecting layer 110 and the respective pixel plates 112 that deflect the respective pixel plates 112 and thus change the corresponding gap portions 114₁.

Light, e.g., from a light source of a projector, passes through substrate 106 and through transparent layer 108. Partially reflecting plate 110 passes a portion of the light onto pixel plates 112 and reflects a portion of the light back through transparent layer 108 and substrate 106. The pixel plates 112 reflect the light back to partially reflecting plate 110, which passes some of the light through transparent layer 108 and substrate 106 and reflects a portion of the light back to pixel plates 112 and the process repeats. That is, multiple reflections occur between the pixel plates 112 and partially reflecting layer 110, with some of the reflected light passing through partially reflecting layer 110 and through substrate 106. This produces optical interference that can be tuned using the gap portions 114₁.

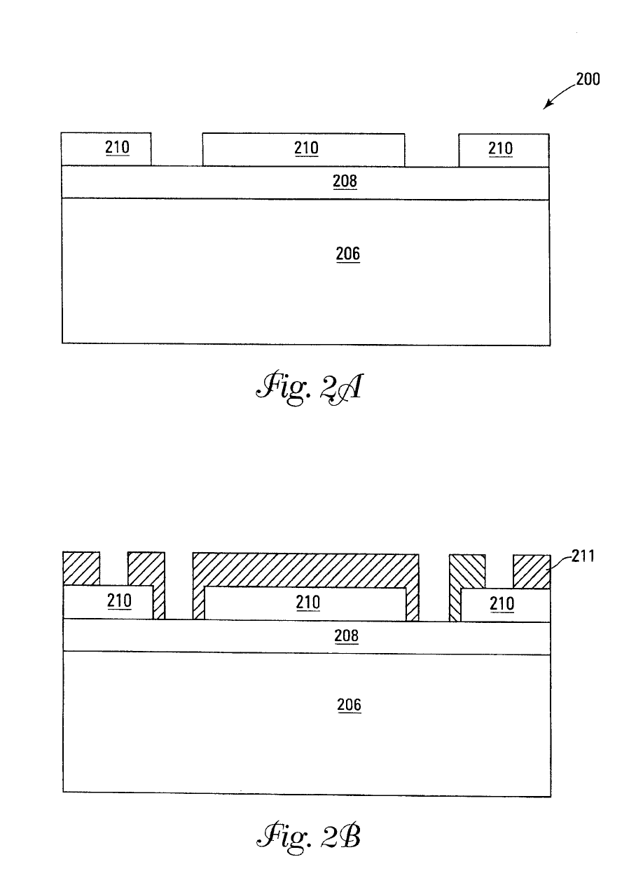

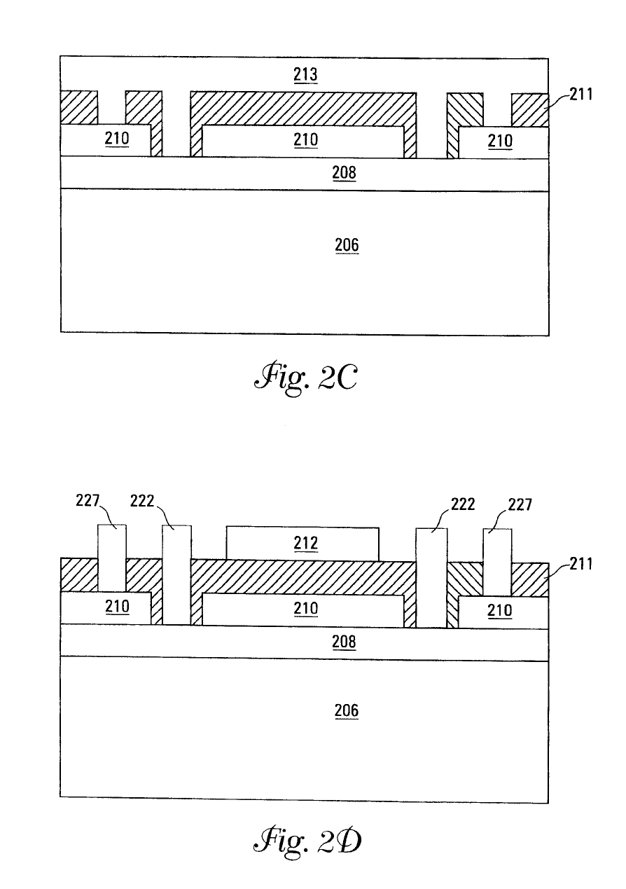

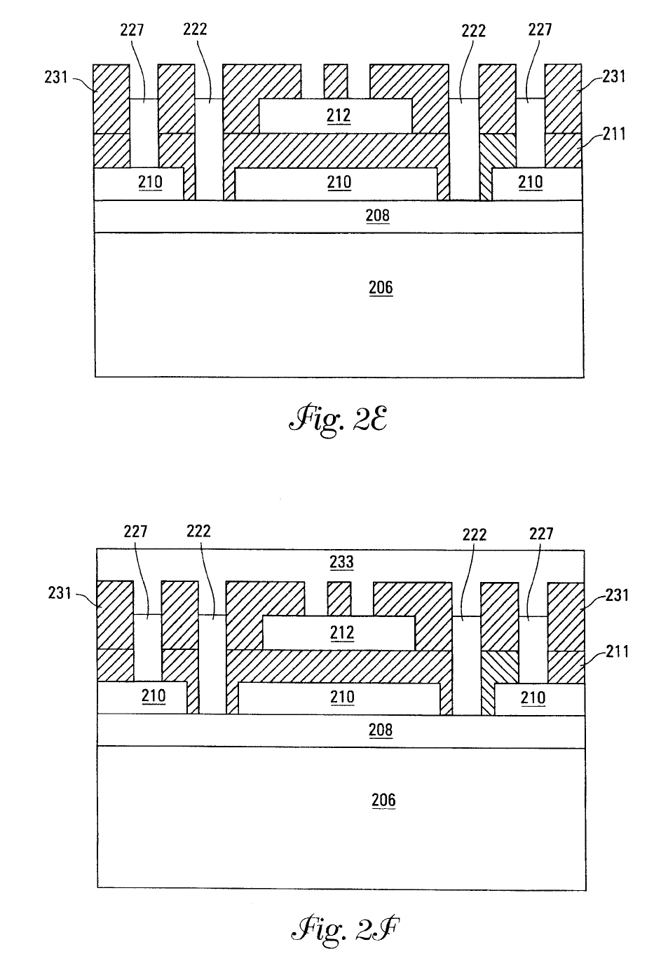

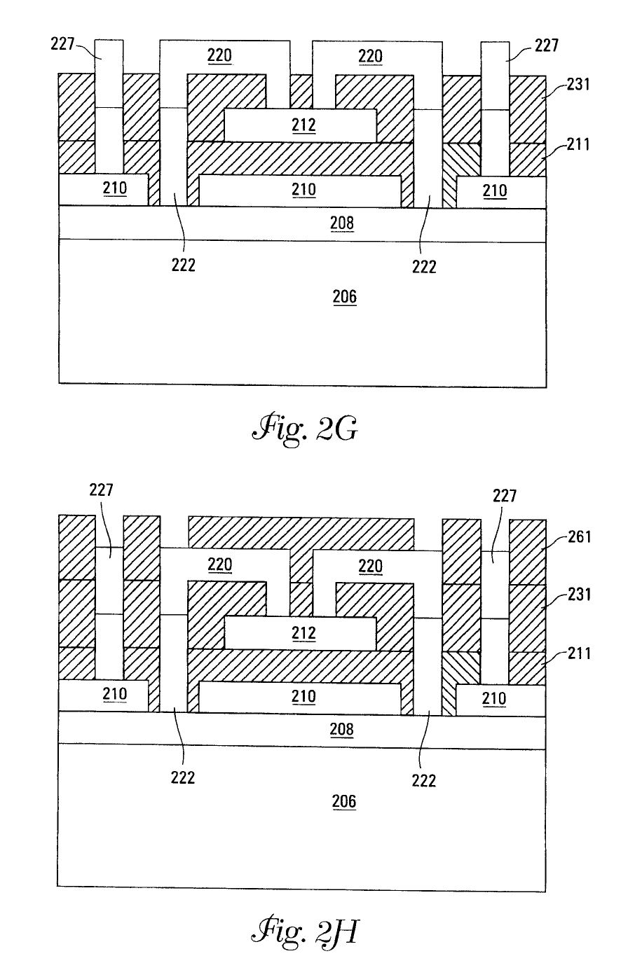

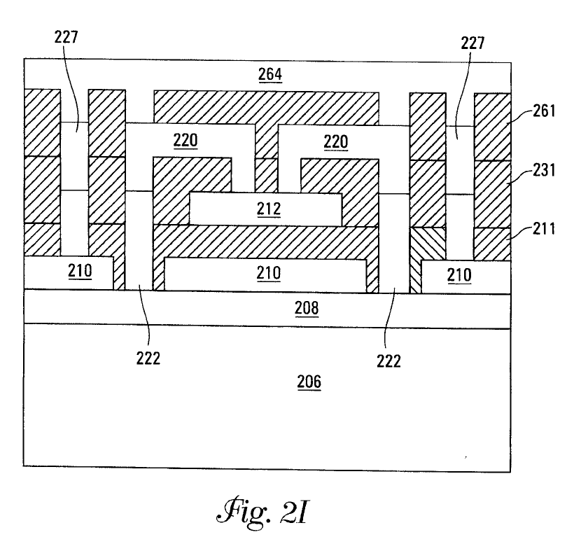

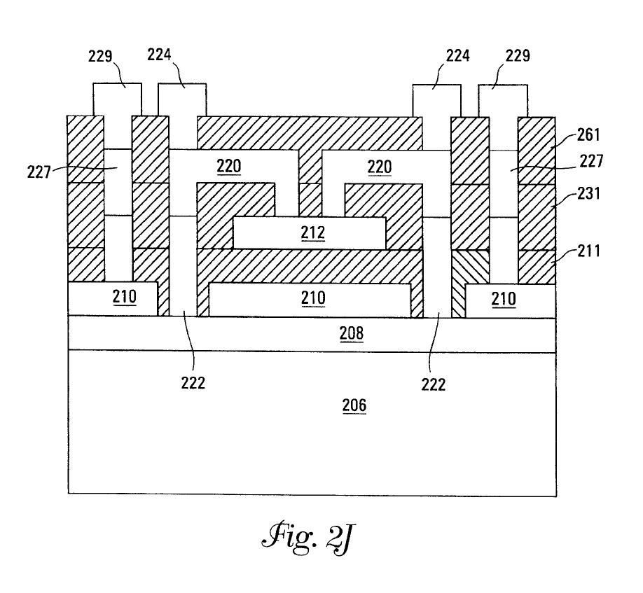

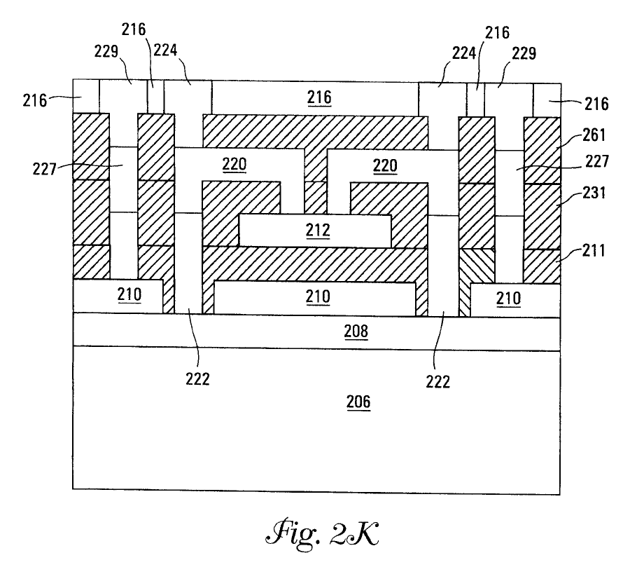

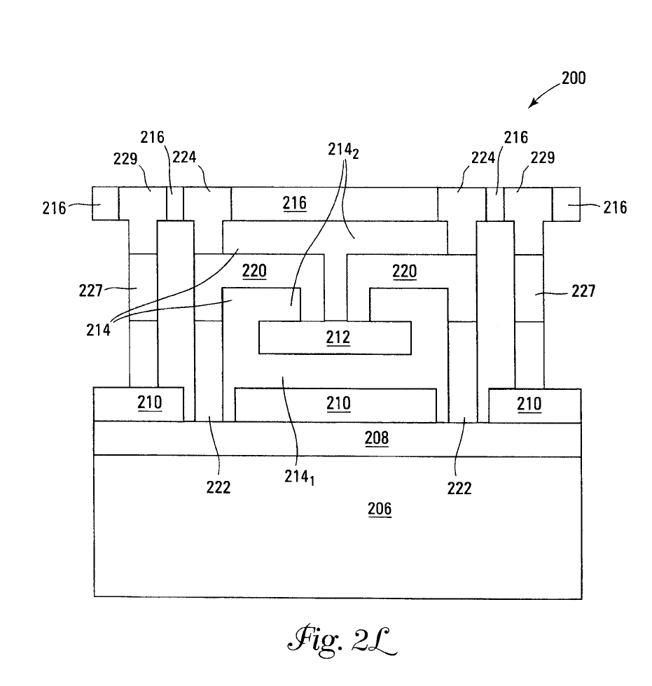

FIGS. 2A-2L are cross-sections of a portion of a device 200 at various stages of fabrication, according to another embodiment. The device 200 includes a first substrate 206, such as an insulator, transparent cover, e.g., of glass, etc., as shown in FIG. 2A. For one embodiment, a transparent layer 208 is formed on first substrate 206 and a partially reflecting layer 210 is formed on transparent layer 208 and is patterned and etched to expose portions of transparent layer 208. For another embodiment, partially reflecting layer 210 is formed directly on first substrate 206. In FIG. 2B, a first sacrificial layer 211 (distinguished by cross-hatching) is formed on partially reflecting layer 210 and for one embodiment is patterned and etched to expose the exposed portions of transparent layer 208 and portions of partially reflecting layer 210. For one embodiment, the first sacrificial layer 211 may be smoothed and/or flattened prior to patterning and etching using chemical mechanical polishing (CMP). The first sacrificial layer 211 will form a portion of a gap, such as a gap portion 114₁ of FIG. 1, between a pixel plate, such as a pixel plate 112 of FIG. 1, and partially reflecting layer 210.

A first metal layer 213, e.g., a layer of TaAl or a layer of TaAl formed on a layer of AlCu is formed on the first sacrificial layer 211 and on the exposed portions of transparent layer 208 and partially reflecting layer 210 in FIG. 2C. The first metal layer 213 is patterned and etched to define a pixel plate 212, first portions of ground posts 227, and signal posts 222 and to expose portions of the first sacrificial layer 211 in FIG. 2D. Note that the pixel plate 212 contacts the sacrificial layer 211, the ground posts 227 contact the exposed portions of partially reflecting layer 210, and the signal posts 222 contact transparent layer 208, or for embodiments without transparent layer 208, first substrate 206.

A second sacrificial layer 231 (distinguished by cross-hatching) is formed on the first metal layer 213, i.e., on pixel plate 212, ground posts 227, and signal posts 222, and on the exposed portions of the first sacrificial layer 211 in FIG. 2E. The second sacrificial layer 231 is patterned and etched to expose portions of pixel plate 212 and to expose ground posts 227 and signal posts 222. For one embodiment, the second sacrificial layer 231 may be smoothed and/or flattened prior to patterning and etching using CMP.

A second metal layer 233, e.g., of TaAl, is formed on the second sacrificial layer 231, on the exposed portions of pixel plate 212, and on the exposed ground posts 227 and signal posts 222 in FIG. 2F. The second metal layer 233 is patterned and etched to form flexures 220 and second portions of ground posts 227 and to expose portions of the second sacrificial layer 231 in FIG. 2G. Note that flexures 220 electrically and physically connect signal posts 222 to the exposed portions of pixel plate 212. Note further that flexures 220 directly overlie pixel plate 212, meaning that when the device 200 is inverted and connected to a second substrate, such as driver 104, as shown in FIG. 1, flexures 220 will be located under the pixel plate 212. That is, flexures 220 are aligned behind pixel plate 212 so that pixel plate 212 obstructs flexures 220 from being viewed through cover 206. This helps to conserve device real estate.

A third sacrificial layer 261 (distinguished by cross-hatching) is formed on flexures 220, ground posts 227, and the exposed portions of the second sacrificial layer 231 and is patterned and etched to expose portions of flexures 220 and ground posts 227 in FIG. 2H. For one embodiment, the third sacrificial layer 261 may be smoothed and/or flattened prior to patterning and etching using CMP. A third metal layer 264, e.g., AlCu, TaAl, or the like, is formed on the third sacrificial layer 261 and on the exposed portions of flexures 220 and on ground posts 227 in FIG. 21. The third metal layer 264 is patterned and etched to form ground contacts 229 in physical and electrical contact with ground posts 227 and signal contacts 224 in physical and electrical contact with flexures 220 and to expose portions of the third sacrificial layer 261 in FIG. 2J. Alternatively, for another embodiment, CMP forms the ground contacts 229.

A protective layer 216, e.g., of TEOS (tetraethylorthosilicate) oxide, silicon oxide, etc., is formed on the exposed portions of the third sacrificial layer 261 and on ground contacts 229 and signal contacts 224 and is patterned and etched to expose portions of the third sacrificial layer 261 and ground contacts 229 and signal contacts 224 in FIG. 2K. For one embodiment, CMP follows patterning and etching to smooth and flatten protective layer 216 and ground contacts 229 and signal contacts 224 so that ground contacts 229 and signal contacts 224 are substantially flush with protective layer 216. For another embodiment, CMP may be used to expose the portions of the third sacrificial layer 261 and ground contacts 229 and signal contacts 224.

The first sacrificial layer 211, the second sacrificial layer 231, and the third sacrificial layer 261 are removed in FIG. 2L to form the portion of the device 200 that includes a gap 214, as indicated by removal of the cross-hatching. Gap 214 contains pixel plate 212 and flexures 220. Note that removal of the first sacrificial layer 211 forms a first gap portion 214₁ between pixel plate 212 and partially reflecting layer 210. Removal of the second sacrificial layer 231 and the third sacrificial layer 261 forms a second gap portion 214₂ between pixel plate 212 and protective layer 216. Note that flexures 220 are contained within the second gap portion 214₂. Flexures 220 support pixel plate 212 within gap 214 and provide a restoring force against which pixel plate 212 returns from an electrostatic actuation driving force applied to pixel plate 212 for some embodiments.

The device is inverted and bonded to the second substrate, such as driver 104 of FIG. 1. This electrically connects signal contacts 224 to a signal line of the second substrate, such as a signal line 132 of a driver circuit 130 of driver 104. Ground contacts 229 are connected to a ground line of the second substrate, such as ground line 136 of driver 104. Note that partially reflecting layer 210 is at a ground state and acts as a first capacitor plate. When electrical signals are applied to pixel plate 212, via signal contacts 224 and flexures 220, pixel plate 212 acts as a second capacitor plate and moves within gap 214 against the restoring force provided by flexures 220. This regulates the size of gap portion 214₁.

It will be appreciated that the bond ring 126 of device 102 of FIG. 1 may be formed, for one embodiment, as described above for ground posts 227.

### CONCLUSION

Although specific embodiments have been illustrated and described herein it is manifestly intended that the scope of the claimed subject matter be limited only by the following claims and equivalents thereof.

1-14. (canceled)

15. A method of forming a micro-display, comprising:
forming a substrate comprising one or more micro-electromechanical system devices;
forming a partially reflecting layer directly on a transparent cover of the micro-display; and
adhering the partially reflecting layer to the substrate so that the partially reflecting layer overlies the one or more micro-electromechanical system devices and is separated from the one or more micro-electromechanical system devices by a gap.

16. The method of claim 15, wherein the partially reflecting layer is a tantalum-aluminum layer and the transparent cover is glass.

17. The method of claim 15, wherein adhering the partially reflecting layer to the substrate comprises adhering the partially reflecting layer to a bond ring of the substrate.

18. The method of claim 15, wherein adhering the partially reflecting layer to the substrate comprises plasma-enhanced bonding.

19-22. (canceled)

23. A micro-display comprising:
a substrate comprising one or more micro-electromechanical system devices; and
a transparent cover having a partially reflective layer formed directly thereon.

24. The micro-display of claim 23, wherein the partially reflective layer is separated from the one or more micro-electromechanical system devices by a gap.

25. The micro-display of claim 23, wherein each of the one or more micro-electromechanical system devices comprises a reflective plate connected to a flexure.

26. The micro-display of claim 25, wherein the flexure is aligned behind the reflective plate.

27. The micro-display of claim 23, wherein the partially reflective layer is bonded to a bond ring of the substrate.

28. The micro-display of claim 27, wherein the bond ring connects the partially reflective layer to a ground line of the substrate.

29. The micro-display of claim 23, wherein the partially reflective layer is bonded to one or more ground posts of the substrate that connect the partially reflective layer to a ground line of the substrate.

30. The micro-display of claim 23, wherein the partially reflecting layer is a tantalum-aluminum layer and the transparent cover is glass.

31-37. (canceled)
